(19) United States
(12) Patent Application Publication
(10) Pub. No.: US 2005/0195173 A1
(43) Pub. Date: Sep. 8, 2005

(54) User Interface for Large-Format Interactive Display Systems

(76) Inventor: Brent McKay, Newport Beach, CA (US)

Correspondence Address: BRENT MCKAY, 3901 WESTERLY PLACE #110, NEWPORT BEACH, CA, 92660, US

(21) Appl. No.: 10/908,685

(22) Filed: May 23, 2005

Related U.S. Application Data
(63) Continuation-in-part of application No. 09/943,585, filed on Aug. 30, 2001.
(63) Continuation-in-part of application No. 10/004,281, filed on Oct. 31, 2001.
(63) Continuation-in-part of application No. 10/660,818, filed on Sep. 12, 2003.
(63) Continuation-in-part of application No. 11/012,055, filed on Dec. 13, 2004.
(63) Continuation-in-part of application No. 10/907,553, filed on Apr. 5, 2005.
(60) Provisional application No. 60/573,543, filed on May 24, 2004.

(51) Int. Cl. G09G 5/00

(52) U.S. Cl. 345/173; 345/179

(57) ABSTRACT

A specialized graphical user interface for use with interactive large-format display systems provides for intuitive operation and flexible content presentation. Designed primarily for use in unattended public spaces, the interface facilitates navigation through complex multi-level content in a consistent, intuitive manner.

### PRIORITY CLAIM

This patent application claims the benefit of the filing date of the U.S. Provisional Patent Application Ser. No. 60/573,543, filed May 24, 2004 and entitled USER INTERFACE FOR LARGE-FORMAT DISPLAY SYSTEMS, the entire contents of which are hereby expressly incorporated by reference. In addition, the present application is a continuation-in-part application of and claims priority under 35 U.S.C. sctn. 120 on U.S. patent application Ser. No. 09/943,585 filed Aug. 30, 2001, U.S. patent application Ser. No. 10/004,281 filed Oct. 31, 2001, U.S. patent application Ser. No. 10/660,818 filed Sep. 12, 2003, U.S. patent application Ser. No. 11/012,055 filed Dec. 13, 2004, and on U.S. patent application Ser. No. 10/907,553 filed May 5, 2005. Each of these five prior applications is incorporated herein by reference.

### FIELD OF THE INVENTION

This invention relates to computer user interface design, and specifically to touch-input navigation interface design structures for use on large-format display systems.

### DESCRIPTION OF THE PRIOR ART

The earliest computer User Interfaces (“UI”) were multi-line text-only displays which used keyboards for input and, when supported, navigation between lines and within lines by using arrow directional keys. With the advent of the Graphical User Interface (“GUI”) and mouse navigation devices, computer UI design allowed for increasingly more complex tasks to be achieved by allowing for graphical elements to be displayed and accessed at random by the user. Most of the early GUI design, however, was optimized around mouse navigation and keyboard input for a single-user desktop display system.

Over the last ten years, the use of computer-based kiosks in public spaces has expanded, and it is now fairly common to see kiosks in malls, airports, and other commercial property venues. It was discovered early on by the kiosk industry that users in these public-space environments generally preferred not to use mice and keyboards; many of these users were not familiar with computers, and in addition there was an acute sensitivity to complex navigation sequences in this environment. As a result, the kiosk industry switched from mice to touch-screen navigation technologies early on, and even today this remains the preferred methodology.

Using touch input technology on a desktop-class display device (typically 14 to 21 inch monitor sizes) required a change in the UI strategy in order to accommodate the relatively large size of the user's finger compared to the small cursor arrow point and fine granularity of the mouse. As a result, UI designs for kiosks typically used larger navigation elements, most typically virtual buttons of some kind. This fact, in conjunction with the need to limit the confusion to new users not familiar with the UI (which the systems needed to accommodate as a rule, not as an exception), caused UI designs to move toward presenting the user with a small number of selections at any given point in the navigation sequence. In addition, the kiosk user's patience for complex multi-level navigation sequences was limited, so good UI designs limited the depth of the navigation tree to only three or four levels at most. These two factors resulted in a severe limitation on the amount and range of content that can be made available on a traditional kiosk system.

As described in related U.S. patent application Publication Nos. 20020078459 and Ser. No. 10/660,818 by the present inventor, the most significant deficiency in traditional kiosk design independent of the UI was its use of desktop-class display systems mounted into freestanding enclosures, which resulted in a very low usage rate in the target environment. As described in these applications, the use of an interactive large-format display system addressed the deficiencies in the prior art by combining the strong visual “pull” of the display with the content navigation system. Rather than positioning the product as a foreign structure in the space with a computer-like display, the large-format interactive model was positioned as a “digital poster” with improved pull (from the larger display images) and in a way which was more tightly integrated into the environment (and therefore less like a foreign structure). Particularly when combined with a well-designed UI and integrated into the facilities directory/wayfinding infrastructure, the large-format interactive display systems substantially improved usage rates in the public-space environments.

As described in the previously-mentioned patent applications by the present inventor, the use of large-format interactive display systems changed many of the fundamentals of the UI design, and those applications describe strategies to address deficiencies in prior art. This patent application describes several improvements to the UI designs outlined in these earlier applications, and in particular addresses large-format display systems 30″ or larger typically used in commercial spaces as one-to-many communication mediums or as consumer entertainment appliances, particularly those in hospitality environments with combined use as entertainment and targeted information sources.

The basic structure of the previously-described UI includes a Default Screen and Content Presentation UI elements. The Default Screen is displayed during non-use periods and includes a Media Window which occupies the majority of the display area, and a navigation bar with fixed virtual buttons. Although the fixed navigation bar suggests to the user that additional information can be accessed by touching the virtual buttons, it presents a limitation on the number of content “categories” which can be included on first level of navigation. In addition, because the virtual button elements are static, they are less likely to be noticed by the user, reducing the opportunity to identify the display as an interactive one.

The present invention addresses these deficiencies in the prior art by utilizing an active call-to-action message which is animated and alerts the user to touch the display to access the content. In addition, some of the Media Segments can be call-to-action messages for an almost full-screen call-to-action.

The Content Presentation structure described in the previous applications included a multi-level scrollable list combined with an adjacent Content Window which was linked to the list elements. Each level of the list was presented as a virtual page element which was overlaid on the previous page element, with the header from the previous page remaining visible. While this allowed for users to monitor their progress through the navigation tree and easily move backwards by selecting one of the previous page's header elements, the structure also added more elements into the List area other than the current list elements, adding additional visual “clutter.”

The present invention addresses deficiencies in the prior art by utilizing the Navigation Bar area for tracking navigation progress and stepping backwards, which was made possible by the elimination of fixed virtual buttons in this space. The net result is less visual clutter in the List area and a more intuitive navigation process.

### SUMMARY OF THE INVENTION

It is an object of the present invention to provide a large-format interactive display UI design that overcomes some of the disadvantages of prior art arrangements.

It is another object of the present invention to provide a large-format interactive display UI design which utilizes an active call-to-action area in conjunction with the main Media Window when in Default Screen mode.

It is another object of the present invention to provide a large-format interactive display UI design which integrates two-way live video communications.

It is another object of the present invention to provide a large-format interactive display UI design which integrates two-way live video communications in such a way as to enable simultaneous viewing and navigation of the other information available from the UI.

It is another object of the present invention to provide a large-format interactive display UI design which facilitates navigating quickly through a long alphabetical listing.

It is another object of the present invention to provide a large-format interactive display UI design which facilitates dual-orientation (landscape and portrait) without requiring multiple versions of the on-demand content to be developed.

It is another object of the present invention to provide a large-format interactive display UI design which accommodates multi-level list navigation with minimal intrusion on the video viewing area.

It is another object of the present invention to provide a large-format interactive display UI design which accommodates hospitality applications and allows for custom messaging within the visual entertainment structure.

### BRIEF DESCRIPTION OF THE DRAWINGS

FIG. 1 illustrates the Default Screen of the Directory UI according to one embodiment of the present invention.

FIG. 2 illustrates the Content Presentation structure of the Directory UI according to one embodiment of the present invention.

FIG. 3 illustrates the Content Presentation structure of the Directory UI according to another embodiment of the present invention.

FIG. 4 illustrates the Content Presentation structure of the Directory UI according to another embodiment of the present invention.

FIG. 5 illustrates the Content Presentation structure of the Directory UI according to another embodiment of the present invention.

FIG. 6 illustrates the Content Presentation structure of the Directory UI according to another embodiment of the present invention.

FIG. 7 illustrates the Content Presentation structure of the Directory UI according to another embodiment of the present invention.

FIG. 8 illustrates the Content Presentation structure of the Directory UI according to another embodiment of the present invention.

FIG. 9 illustrates the Content Presentation structure of the Directory UI according to another embodiment of the present invention.

FIG. 10 illustrates the Content Presentation structure of the Directory UI in Portrait Mode according to one embodiment of the present invention.

FIG. 11 illustrates the Content Presentation structure of the Directory UI in Portrait Mode according to another embodiment of the present invention.

FIG. 12 illustrates the Menu structure of the Entertainment UI according to one embodiment of the present invention.

FIG. 13 illustrates the Menu structure of the Entertainment UI according to another embodiment of the present invention.

FIG. 14 illustrates the Menu structure of the Entertainment UI according to another embodiment of the present invention.

FIG. 15 illustrates the Menu structure of the Entertainment UI according to another embodiment of the present invention.

FIG. 16 illustrates the Menu structure of the Entertainment UI according to another embodiment of the present invention.

FIG. 17 illustrates the Menu structure of the Entertainment UI according to another embodiment of the present invention.

FIG. 18 illustrates the Menu structure of the Entertainment UI according to another embodiment of the present invention.

FIG. 19 illustrates the Menu structure of the Entertainment UI according to another embodiment of the present invention.

### DETAILED DESCRIPTION OF THE PREFERRED EMBODIMENT

The following description relates to a Client Software Application with a specialized Graphical User Interface (“GUI”) which is optimized for use with interactive large-format Display Systems. It provides for intuitive operation and flexible content presentation when in interactive mode, while also supporting non-interactive Display Systems through a simple programmable “switch.” Designed primarily for use in unattended public spaces, the interface facilitates navigation through complex multi-level content in a consistent, intuitive manner.

The Client Application is designed to be highly user-programmable in that all of the site-specific content can be configured through a separate User Interface (“UI”) Administration software program (most likely run as an automated web service). Using the UI Administration program, users simply input text into a multi-level list structure and associate an image file with each list element. The Media Window content is developed by loading image file segments and setting a play schedule (see below). Once completed, the user sets some predetermined UI options and the Client Software application runs the UI, which is now customized to display the user's specific content.

Because the Client Application can be easily customized by the user, it eliminates the need for developing a custom UI, which can be an expensive process.

An additional feature of the Client Application UI is that it can readily support landscape or portrait display orientations simply by selecting the appropriate setting in the UI Administration program. Because the List and Content Window elements (see below) are the same size in either orientation, no scaling or other modification is required.

FIG. 1 illustrates the general structure of the Default Screen of the Landscape Directory UI, which runs during periods when no user input has been received within a system-defined time-out period. The UI consists of Media Window 101, Navigation Bar 102, and Scrolling Call-To-Action 103 visual elements. The Media Window 101 covers most of the display surface and typically runs a “Media Loop,” or series of media segments which are displayed in accordance with a programmable schedule. The Media segments are simply still, animated, or full-motion video files which are uploaded with the UI Administration program and play in accordance with the schedule set by the UI Administration program.

The Navigation Bar 102 provides a background against which a Scrolling Call-To-Action 103 message can be displayed concurrent with the Media Window 101 content. The Call-To-Action 103 message is used to notify users the display system is interactive and to instruct them to touch the screen to access additional information. The Call-To-Action 103 message itself can include text and graphics elements, and can be animated to better attract users attention. Additional call-to-action visuals can be included in areas outside the active screen area, such as on fixed signage near the Display System. The Navigation Bar 102 color can be any color supported by the system and UI Administration program and be opaque, semitransparent, or completely transparent. Generally, a solid opaque color would be preferred for best readability of the Call-To-Action 103 message content.

As described in earlier patent applications by the present inventor, the Navigation Bar 102 and Scrolling Call-To-Action 103 messages could implement complimentary color sets in order to eliminate burn-in on phosphor displays. Because the Default Screen shown in FIG. 1 is the one displayed most frequently in typical applications, this is the screen where burn-reduction UI design is the most important.

As described in U.S. patent application 20020078459 by the present inventor, the traditional approach to Default Screen UI design representative of prior art was to use fixed virtual buttons to suggest to the users additional information was available by touching the screen at the virtual button location. The problem with this approach is that the fixed buttons are not as likely to attract the attention of the users as animated elements are. Additionally, having multiple buttons typically causes users to scan through them to determine if there might be anything of interest “behind the curtain.” These few seconds of additional decision time are of critical importance in a public-space application, and in many cases will result in the (potential) user's interest to be lost before they engage the system. The present invention's use of an animated Call-To-Action 103 message both attracts the user's attention more readily, and focuses the message to the potential user more effectively once their attention is grabbed (“touch the screen” rather than “touch this button for this content, or this button for this other content, or this other button . . . ”). The net result is a higher percentage of users will engage the system.

The present invention addresses deficiencies in the prior art by including an animated call-to-action message area in conjunction with the primary media window, thereby improving the chances that users will recognize the system as interactive.

To draw the distinction between the prior art in large-format interactive UI designs and the present invention more clearly, the present invention addresses deficiencies in the prior art by integrating an animated message coaxing users to touch the display rather than displaying fixed virtual buttons to convey the fact that the display is interactive.

The present invention is therefore novel in its application of UI design strategy, and unique in its capabilities, in that it addresses the stated deficiencies in the prior art.

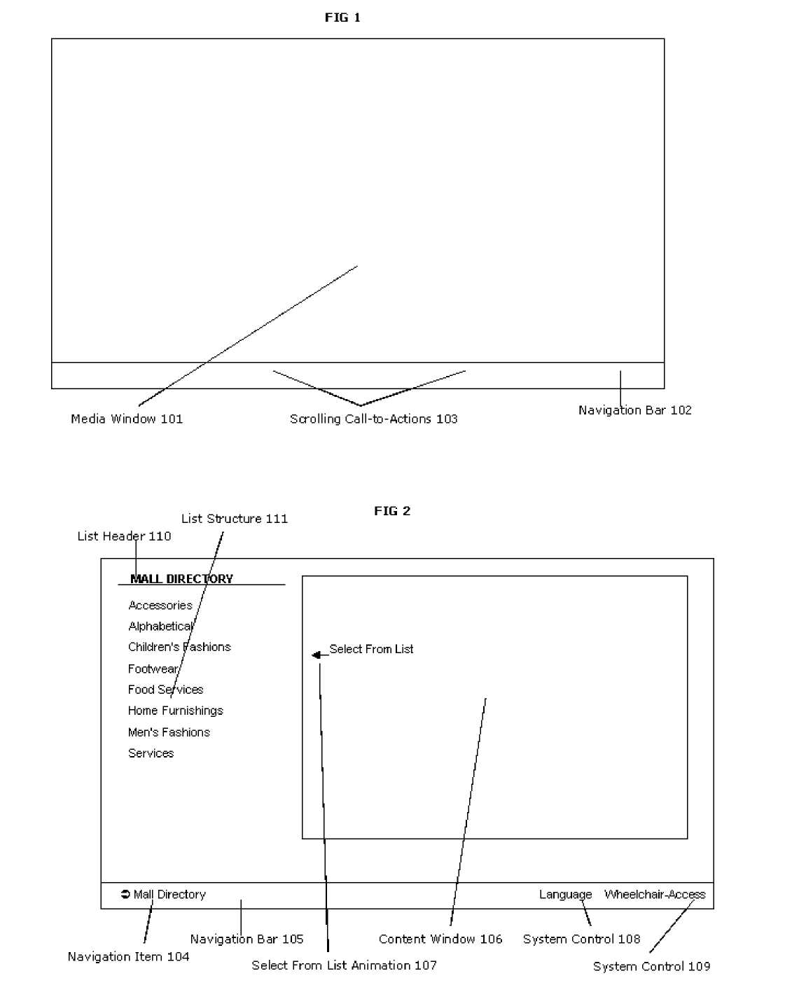

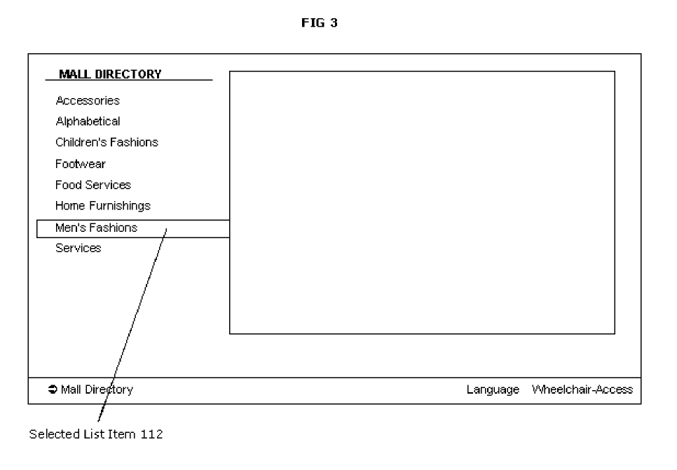

FIG. 2 illustrates the general structure of the Interactive Screen which is presented once the user touches the screen while in Default Screen mode (see FIG. 1). The Interactive Screen has several visual elements including List Header 110, List Structure 111, Content Window 106, and a Select From List Animation 107 which is presented in the area where the Media Window 101 was previously located while in Default Screen mode (FIG. 1).

Referring again to FIG. 2, the Scrolling Call-To-Action 103 message of the Default Screen mode (FIG. 1) is replaced with Navigation Item 104 and system control elements (System Control 108 and System Control 109 shown as examples).

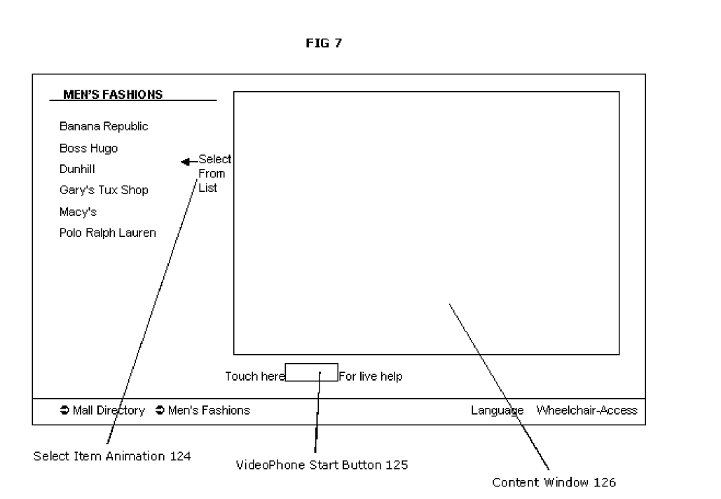

The List Header 110 displays the primary description for the content being displayed, such as “Directory” or “Available Information.” The List Structure 111 presents the user with a list of information or sub-categories available. Each item in the List Structure 111 is “hot,” meaning it can be selected to “drill down” to additional content. The Select From List Animation 107 helps to train the user that the List Structure 111 items are hot; additional training can be accomplished with audio instructions and full-size Content Window 106 messages. The Select From List Animation 107 is intended to be a standard element which is programmed to run automatically at the appropriate time during the interaction and in the same place. This eliminates the need for custom programming by the user for a feature common in all applications. The Select From List Animation 107 can be located as an overlay in the Content Window 106 as shown in FIG. 2, or outside the Content Window 126 as shown in FIG. 7.

Referring again to FIG. 2, the Content Window 106 displays the image file associated with the text showing in the List Header 110 (“Mall Directory” in this example). As mentioned previously, the UI Administration program facilitates loading the List Header 110 text and associating with it an image file. Similarly, the items shown in the List Structure 111 are loaded though the same program as text fields and each line of text in the list is associated with its own image file.

The Navigation Item 104 displays the navigation history information, which initially would be the List Header 110 text as shown in FIG. 2. Optionally, the initial navigation item can include the Default Screen (FIG. 1) as illustrated in FIG. 20 (Navigation Item 104a). This would allow the user to navigate back to the Default Screen by touching the “Main Screen” text shown in the figure.

The System Control visual elements (System Control 108 and System Control 109 shown in FIG. 2) provide the user with a means to modify the general behavior of the system. The two examples shown in the figure were first introduced in previous patent applications of the present inventor, and include a method for changing the language for text (and potentially audio) elements in the UI (see System Control 108) and providing for navigation by users in wheelchairs (see System Control 109). When the “Change Language” text of FIG. 2 is selected (System Control 108), a list of available languages is presented to the user for selection. Once selected, the Client Application replaces the text content fields with the modified language version. Generally, the system would reset itself to the Native Language set by the UI Administration program once returning to the Default Screen (FIG. 1), which would be after a predetermined (or programmable) “time-out” period or upon selection of the Default Screen text in the Navigation Item 104a as described previously.

The UI Administration program would be used to establish which languages are supported, to generate automated translations of text, to facilitate review of translations by the user or Language Review service, and to load alternate image files if needed for some or all of the alternate language versions of the UI.

Referring again to FIG. 2, the wheelchair navigation control (System Control 109) presents the user with a mechanism for navigating all available elements of the UI without requiring the user to reach above a specific height on the display. The actual height from the ground surface is determined in the U.S. by ADA (Americans with Disabilities Act) specifications and corresponds to a certain location on the UI based on screen size and screen mounting specifications. One example of a navigation structure to facilitate this is shown in FIG. 111 (see Arrow Navigation Structure 140 and Arrow 139). The user would use the four directional elements of the Arrow Navigation Structure 140 to move the Arrow 139 pointer to the desired location on the screen and then touch the center portion of the Arrow Navigation Structure 140 to make the desired selection. This would simulate a user actually touching the same point as the Arrow 139 pointer.

The transition from the Default Screen to the Interactive Screen shown in FIG. 2 can be improved visually by including an appropriate animation of the main screen visual elements rather than simply displaying them in their ultimate locations.

When a list item of the List Structure 111 is selected (see FIG. 2), the selected item is highlighted in some way as illustrated by Selected List Item 112 shown in FIG. 3. This provides visual feedback to the user that the item is, in fact, “hot,” and that the selection was recognized by the system. Additional audio feedback of some kind will help reinforce the visual feedback.

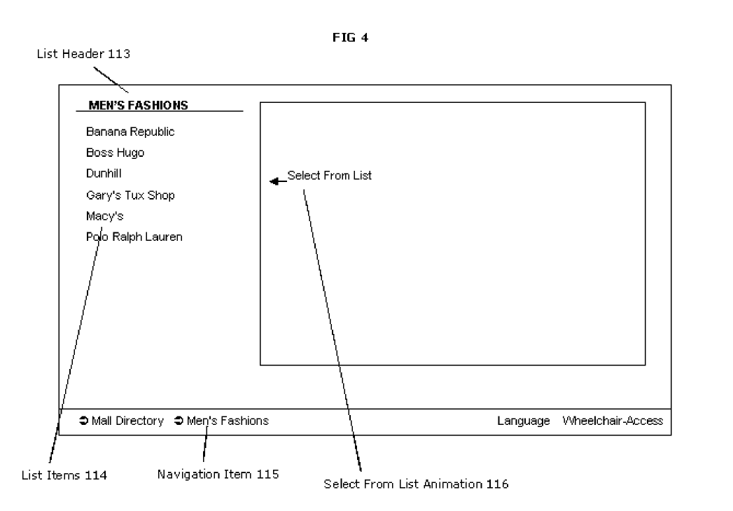

If the selected item is a sub-list category item (rather than a content item), after selection and visual/audio feedback is provided (FIG. 3) and the List Structure 111 (FIG. 2) switches the list content and navigation history as shown in FIG. 4. The List Header 113 text becomes the previously-selected list item text (“Men's Fashion” in the example shown in FIG. 3 and FIG. 4) and the list items are changed to the new list items which are programmed for the sub-list category.

If, on the other hand, the selected item was content item rather than a sub-list category item, after selection and visual/audio feedback is provided the Content Window 106 (FIG. 2) would simply switch the image file associated with that item and now additional list changes would occur.

The transition between nested lists can be improved visually by including appropriate animations such as “sliding” the old list down off the page while the new list visually “slides” down from under the List Header 113 visual element (FIG. 4).

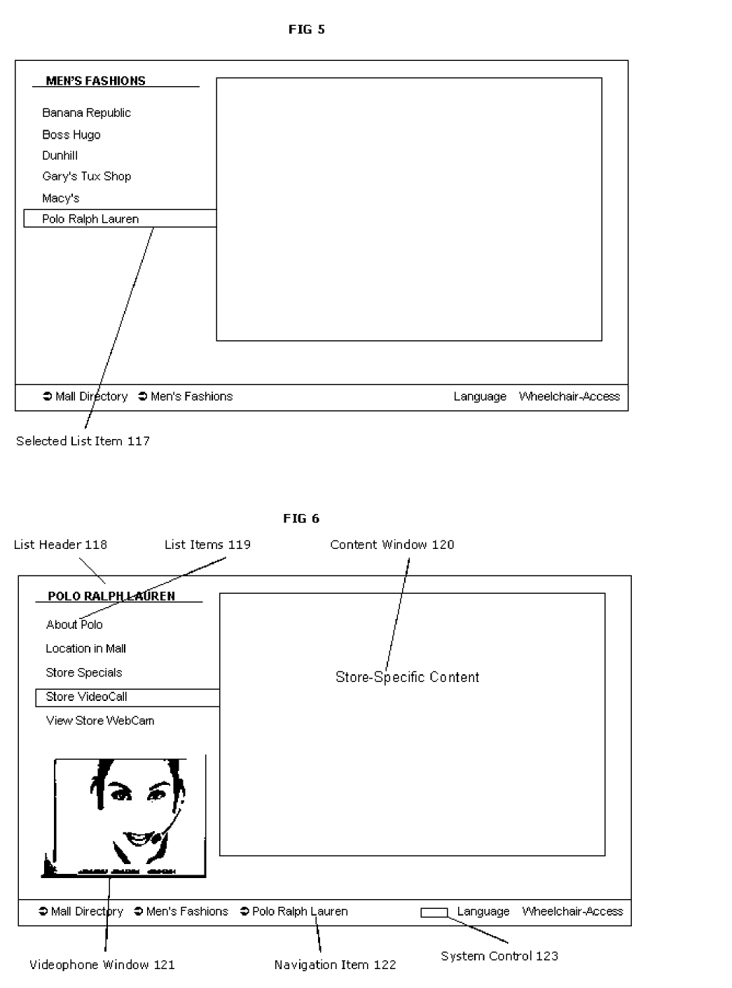

Referring to FIG. 6, the Navigation Item 122 text matches the List Header 118 text as before, allowing the user to see the current location in the multi-level list tree as well as the previous category and sub-category selections of the navigation history. Also shown in the figure is an additional system control example (System Control 123) which illustrates a live videophone function. In this example, Live Help can be made available as a System Control item, which launches a Videophone Window 121 at the base of List Items 119 area. The Videophone Window 121 displays the receiving end of a full-duplex videophone connection which utilizes a local camera and microphone at the Display site in order to facilitate the two-way communications.

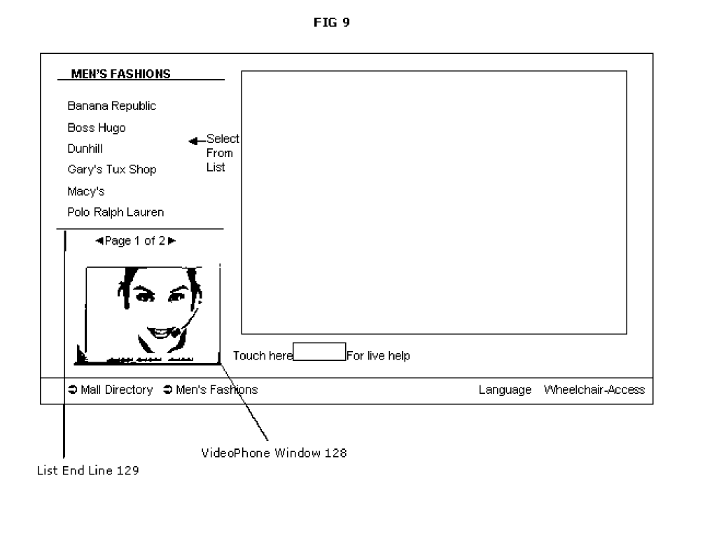

Referring again to FIG. 6, locating the Videophone Window 121 outside of the Content Window 120 area allows the Live Help Customer Service Representative to fully navigate the UI for the user from a remote location (with a properly designed Client Application), without obscuring the Content Window 120 information. For cases where the List Items 119 would extend past the top of the Videophone Window 121, the Client Application would shorten the list space to accommodate as shown in FIG. 9. For applications where Live Help was not available, but some items in the list content tree made available videophone services, then the Videophone Window 121 could be launched automatically when that level of the content tree was reached, as a content item list selection, or as a separate VideoPhone Start Button 125 visual element as shown in FIG. 7.

Referring to FIG. 7, the Select Item Animation 124 is located between the list items and the Content Window 126, which provides a method for incorporating the animation without obstructing the Content Window 126 or the list items.

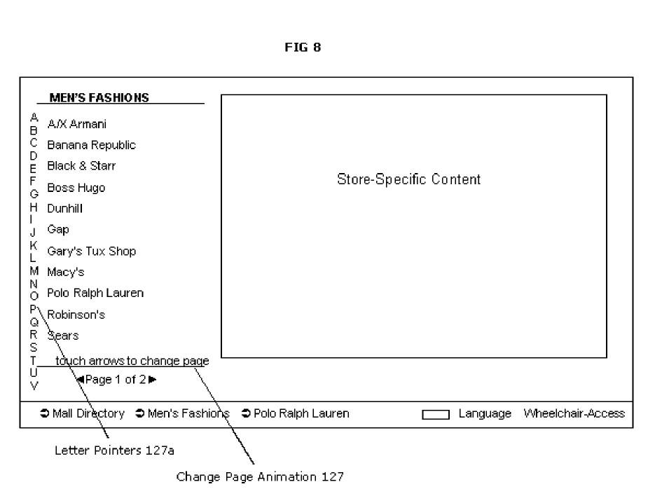

Referring to FIG. 8, the Change Page Animation 127 instructs the user on how to navigate through long lists which cannot be displayed on a single “page.” Also illustrated is a method for quickly navigating through very long lists of alphabetized text list elements, with the inclusion of letters which move the list to that section when selected by the user. The intuitive operation of this function is improved by including list items for each letter of the alphabet which are used to visually separate each section of the list (not shown). When the letter “C” is selected, the top item in the presented list would be something like “ . . . C . . . ” with the first item that starts with the letter “C” under it. In this way, when letters are selected for which no list items existed, the list separator would still show up providing feedback to the user that the selection was made properly.

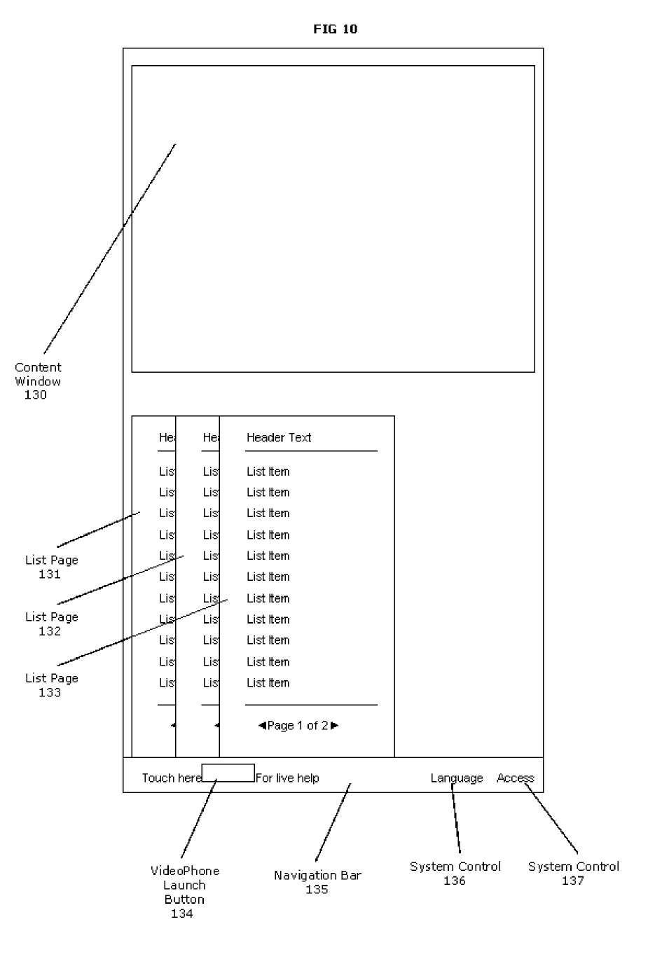

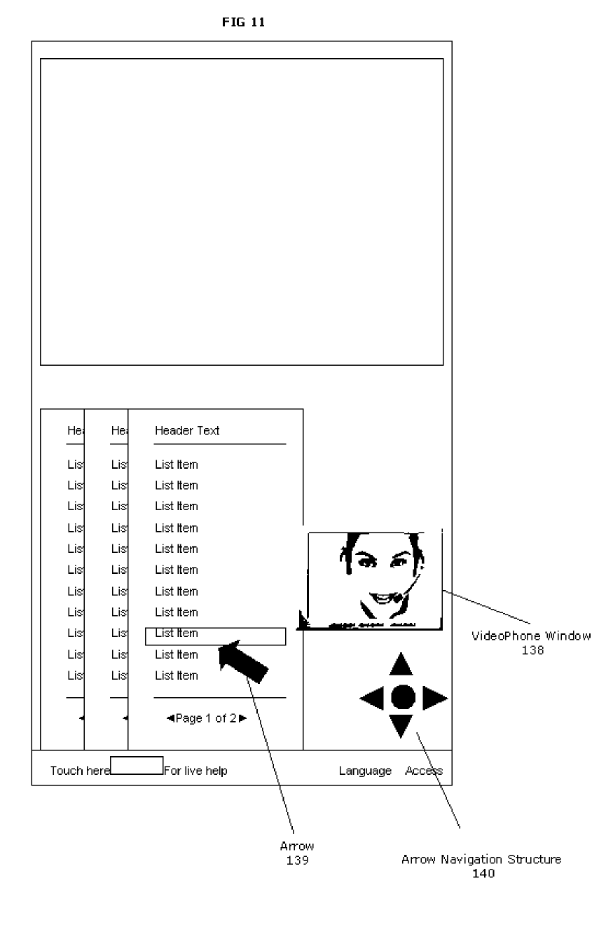

Referring to FIG. 10, the same visual elements of the Interactive Screen can be reconfigured to support portrait mode display orientations. In this mode, the Content Window 130 is positioned at the top of the screen, since the bottom half of the screen would be easier to reach in the typical installation. Notice that the Content Window 130 is approximately the same dimension as the Content Window 126 shown in FIG. 7. This allows the same Content Window image files to be used in both orientation modes with little or now scaling. This is beneficial in that scaling may degrade or alter the image and could therefore require developing two sets of image files if the Content Window sizes were different.

Referring again to FIG. 10, the navigation history illustrated in FIG. 2 (see Navigation Item 104) is replaced by an overlapping virtual page structure (see List Page 131, List Page 132, and List Page 133 visual elements). This is because in the portrait mode the Navigation Bar 102 (FIG. 1) is not wide enough to display three or four levels of typical text as required. In addition, the overlapping virtual page structure is more intuitive to operate and the necessary screen area is available in this mode whereas it is not available in the landscape mode.

Otherwise, the Navigation Bar 135 operates in a similar way, including the presentation of system control items (see System Control 136 and System Control 137), Videophone Launch Button 134, and the Animated Call-To-Action as described previously in connection with the Default Screen.

FIG. 11 illustrates one possible location for the Videophone Window 138 which would have minimal impact on the other visual structures and content.

With respect to reconfiguration between portrait and landscape orientations, there are no known prior art examples of a dual-orientation interactive UI, particularly one designed for large-format display systems. In practice, allowing a combination of orientations provides additional flexibility for the digital signage owner in that certain site locations lend themselves to one or the other orientation but in many cases not all of the site locations are best suited to only one orientation. Therefore, the added flexibility provides additional product value. However, perhaps the greatest benefit is in the fact that all of the site-specific content can be developed once and deployed in either orientation (except for the media segments, which are out of necessity orientation-specific).

The present invention addresses deficiencies in the prior art by providing a dual-orientation UI in which the same user-programmable on-demand content can be deployed in a portrait or landscape orientation.

To draw the distinction between prior art in large-format interactive UI designs and the present invention more clearly, the present invention facilitates all of the site-specific content to be automatically reconfigured for portrait or landscape orientation simply by selecting the orientation in the UI Administration program.

The present invention is therefore novel in its application of UI design strategy, and unique in its capabilities, in that it addresses the stated deficiencies in the prior art.

The present invention describes improvements to prior art in the area of UIs optimized for use with interactive large-format Display Systems. This class of applications is a subset of what is known in the industry as “Digital Signage,” which includes all applications wherein electronic display systems are physically located in commercial facilities with public access to the system or display content directed to the public.

Traditionally, these Digital Signage systems have used “open system” architecture wherein a general-purpose PC hardware running one of several standard operating systems (“OS”) are used in conjunction with separate display hardware like plasma or LCD monitors. In addition to the OS, the PC runs a Digital Signage client application software program which facilitates the Digital Signage-specific operation of the system.

FIG. 21 illustrates the main components of a traditional Digital Signage System 400. It includes a PC 401 running OS 402 software and Client Application 403 software. The PC 401 sends video data to the Display Monitor 405 through the Video Interface 404, which is typically a standard interface protocol such as analog RGB or DVI. For interactive Digital Signage applications, Touch Sensor 405 hardware is added as an overlay to the Display Monitor 405 hardware, and interfaced to the PC 401 through a Touch Sensor Interface 409 cable, which is typically a serial data interface such as RS-232. The PC 401 is connected to the network via Network Interface 407, which is typically an Ethernet type.

To properly set up and configure a system like this currently requires someone experienced in PC systems and software, network technology and OS configuration. For large Digital Signage networks, Information Technology (“IT”) professionals are used for system installation and configuration. However, many potential Digital Signage customers need only a small number of display systems and using IT professionals is cost prohibitive. As a result, a Digital Signage system which could be installed, configured, and managed without IT professionals would address a large segment of the market which is currently not being served by prior art implementations.

FIG. 22 illustrates a preferred embodiment of the present invention which addresses these deficiencies in the prior art. The system is a fully integrated Digital Signage system which can be installed, configured, and managed by a typical consumer without employing professional IT services. The VNA (“Visual Network Appliance”) Digital Signage System 350 includes the VNA Hardware Components 300 and VNA Software Components 309 elements as shown.

Referring again to FIG. 22, the VNA Hardware Components 300 includes a Processor 301, Display Interface 302, and Display Panel 303. For interactive Digital Signage applications, it includes the optional Touch Components 304. Unlike the traditional Digital Signage System 400 shown in FIG. 21, the VNA Digital Signage System 350 integrates all of the hardware components into a mechanically contiguous system which can be shipped and installed as a single unit. The VNA Digital Signage System 350 is connected to a standard AC power outlet and interfaces to the network via the Network Interface 307, which can be wired Cat-5 type or some form of industry-standard wireless data communications protocol. From a physical installation standpoint, all of the required site preparation work utilizes standard construction techniques to provision power and data communications cabling as required. The VNA Hardware Components 300 is then installed as a single system, eliminating the traditional systems integration work necessary when installing a traditional Digital Signage System 400. This aspect of the current invention facilitates installation of the VNA Digital Signage System 350 hardware at the site without requiring professional IT services to do the systems integration work as is typically required for a traditional Digital Signage System 400 (FIG. 21).

Referring again to FIG. 22, the VNA Software Components 309 includes a User Interface 310, VNA Application 311, Other System Software 312, and Operating System 313 software applications. The Operating System 313 is one of any number of standard computer operating systems available in the marketplace; the VNA Application 311 is the application-specific program which converts the general-purpose processor and Operating System 313 into a Digital Signage application; the User Interface 310 is the component of the VNA Application 311 which controls the visual elements seen by the user on the Display Panel 303 as well as controlling any system interactivity elements. Other System Software 313 which is independent of the Operating System 313 and VNA Application 311 may also run on the system.

Traditional digital signage systems like the Digital Signage System 400 shown in FIG. 21 require IT professionals to configure the software in order for the system to operate properly. Some of this software configuration is typically done on-site as a part of the initial system configuration and testing process, increasing the cost of this part of the process significantly. Although many common configuration, update, and management tasks can be done remotely, the system must be configured in such a way as to communicate with the network first.

Referring again to FIG. 22, in the preferred embodiment of the present invention the VNA Software Components 309 are configured in such a way so that on initial power-up of the system, end-user access to the Operating System 313 is blocked and a network configuration screen (which is a part of the VNA Application 311 or the Other System Software 312 applications) is presented to the user. For non-interactive VNA Digital Signage System 350 systems, some kind of user input device such as a PC keyboard must be used; for interactive VNA Digital Signage System 350 systems the touch screen and a “virtual keyboard” (software program designed to emulate keyboard inputs using a touch screen interface) can be used. The network configuration screen allows the site-specific network setting to be input and tested.

Referring again to FIG. 22, in the preferred embodiment of the present invention the VNA Application 311 also blocks end-user access to the Operating System 313. It is designed to automatically communicate with a predetermined server (or group of servers) once the network configuration process is properly completed by the end-user (which facilitates Internet accessibility by the VNA Digital Signage System 350 and proper identification of the VNA Digital Signage System 350 by the “backend” servers on the network).

The described software aspects of the current invention facilitates configuration of the VNA Digital Signage System 350 software at the site without requiring professional IT services to do the software configuration work as is typically required for a traditional Digital Signage System 400 (FIG. 21).

Combining the hardware and software elements of the present invention as shown in FIG. 22 and described above, it is possible market a Digital Signage system which can be shipped to the customer's site as a contiguous system which can be plugged in, turned on, self-configured, and thereafter automatically updated and managed over the network. All of this can be done cost effectively without high-cost professional IT services. When using other aspects of the present invention, the site-specific content of the Digital Signage system can loaded and managed through a web service, thereby eliminating the need for professional IT services for this aspect as well.

The present invention addresses deficiencies in the prior art by providing means to install, configure, and manage a Digital Signage system by a typical end-user without the need for professional IT services.

To draw the distinction between prior art in Digital Signage systems and the present invention more clearly, the present invention integrates all of the previously disparate hardware and software elements of a Digital Signage system into a single contiguous system which blocks access to the operating system and facilitates end-user's local software configuration only as required to enable proper communication with the network. All site-specific software configuration and updates are then made over the network and through web services where user-input is involved.

The present invention is therefore novel in its application of Digital Signage design strategy, and unique in its capabilities, in that it addresses the stated deficiencies in the prior art.

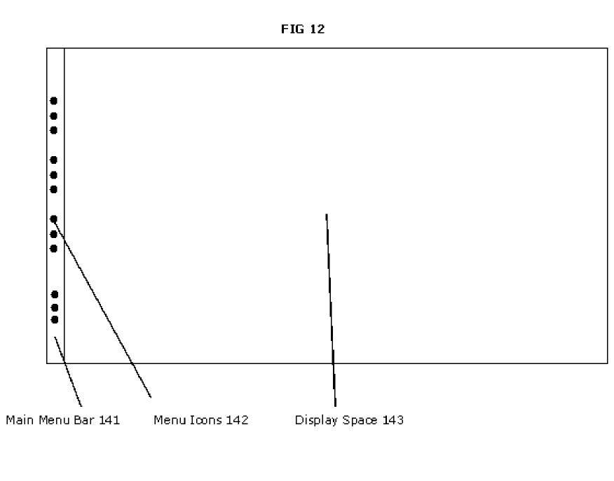

FIG. 12 illustrates the basic structure of an “Entertainment UI” which is designed for hotel (“hospitality”) applications where viewing entertainment such as movies and TV is combined with traditional PC applications such as web browsing or word processing. Unlike known prior art in the field such as Microsoft's “Windows Media Center,” this Entertainment UI locks out consumer access to the OS and is therefore particularly useful in hospitality types of applications where open access to the OS would be unacceptable. In addition, the Entertainment UI which is the subject of the preset invention is intended to be suitable for use with large-format touch-input display systems such as plasma or large-format LCD displays equipped with suitable touch-input electronics, and in particular 16:9 aspect versions of these displays. Additionally, the Entertainment UI is designed to be suitable for navigation using a remote touch input device which emulates direct touch input so that the UI could be navigated from a distance without the need for traditional remote control devices (which represent deficiencies in prior art as described in more detail below), and in a more intuitive manner.

FIG. 12 illustrates the UI of the present invention with the Main Menu Bar 141 and the associated Menu Icons 142. In the preferred embodiment of the present invention, the Main Menu Bar 141 would remain on-screen at most times, but would programmatically change from a dimmed-version to a full-bright version (or darker vs. lighter colored background, graphics, and text) depending on environmental conditions. In this way, the Main Menu Bar 141 would be visually muted at times, but would always be present so that users would be able to switch functions at any time by selecting one of the Menu Icons 142. Furthermore, because of this design strategy, the optimal use of screen real estate would be to use only icons on the Main Menu Bar 141 because of the fact that text would require more space and, particularly when the Main Menu Bar 141 was located on the side of the screen, require that the Display Space 143 be reduced to accommodate the wider Main Menu Bar 141. In this application a normal and frequent use of the system is to view TV and/or movies and it is generally preferred to use as much of the screen area as possible when doing so. However, a full-screen viewing area, which is representative of prior art, does not lend itself to intuitive on-screen navigation because elimination of the Main Menu Bar 141 suggests that those functions are not available. Even if the Main Menu Bar 141 were programmed to show back up with any touch input when running in full-screen video mode, the fact that it was not visible during some period of time would likely confuse a significant segment of the new user population.

While the Main Menu Bar 141 could theoretically be located on any of the four sides of the screen, in the preferred embodiment of the present invention it is located on the left side as shown in FIG. 12. Furthermore, the FIG. 12 screen area is shown in 16:9 aspect ratio because of the trend in consumer entertainment displays towards this format. While the present invention is optimized for such a display, it is not intended to be limited to 16:9 displays. In addition, the Menu Icons 142 are designed to be of appropriate size and spacing to be suitable for touch-input navigation on display sizes typical of entertainment applications.

Another potential aspect of prior art which relates to the present invention comes from traditional personal computer (“PC”) UI design. Whereas a PC UI like Microsoft's “Windows XP” was designed for single-user desktop applications with mouse and keyboard navigation, it does include a menu bar which can be moved by the user from the default location at the bottom of the screen to either side or the top. However, the UI was not intended for touch-input navigation and it does not lend itself well to exclusively touch-input navigation. Furthermore, the present invention deals specifically with a different class of application, that of a hybrid PC and entertainment system (“Converged Entertainment System”), and one which is optimized for large-format displays to me viewed by multiple users simultaneously and wherein a frequent use is to watch TV and/or movies. Microsoft's currently introduced UI which relates to this class of applications is their “Windows Media Center” which is designed for the next-generation entertainment systems which combine traditional TV and traditional PC functions.

While the Media Center UI is designed for the same class of Converged Entertainment Systems as the present invention, it is optimized for consumer applications where access to the OS is required and familiarity with the basic navigation is assumed. By contrast, the present invention assumes new users unfamiliar with the UI, and limits access to the OS by the end-user so as to minimize operating failures being introduced to the system.

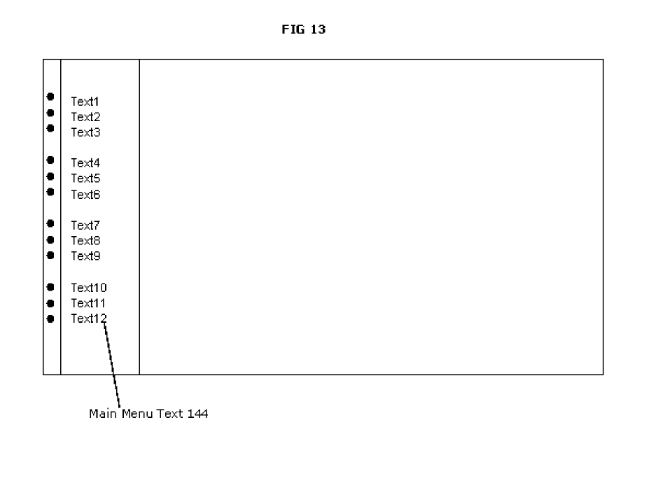

FIG. 13 illustrates the UI with the Main Menu Text 144 visible. This additional UI navigational feature adds text descriptions to the Menu Icons 142 (FIG. 12) of the Main Menu Bar 141 (FIG. 12). Functionally, selection of the text is identical to selection of the associated icon. However, the Main Menu Text 144 element would programmatically be displayed at certain times in order to assist in the navigation process, and programmatically disappear at other times in order to minimize encroachment on the Display Space 143 (FIG. 12) area of the UI. A basic strategy would be to visually “slide out” the Main Menu Text 144 visual element from left to right from “underneath” the Main Menu Bar 141 visual element (FIG. 12) once any portion of the Main Menu Bar 141 was touched, and to visually “slide it back” after a preset period of inactivity from the touch input electronics.

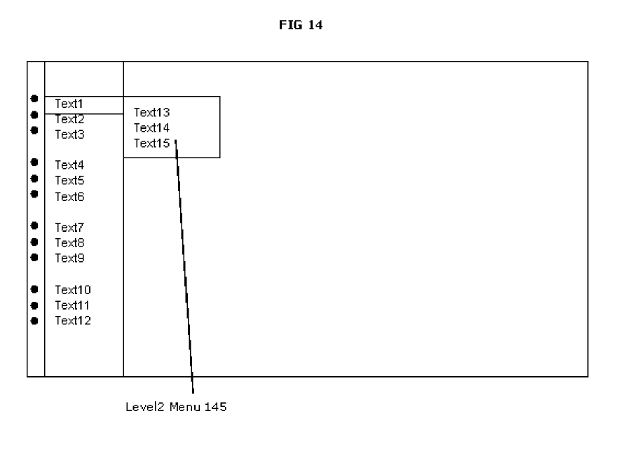

FIG. 14 illustrates a secondary level of menu navigation. The Level2 Menu 145 visual element shows how icons and text might be displayed when a selection is made on the Main Menu Bar 141 (FIG. 12). More efficient screen utilization would be achieved using a variable-width strategy which set the width of this visual element base on the maximum width of the displayed text, perhaps with an overall system maximum width specified as well.

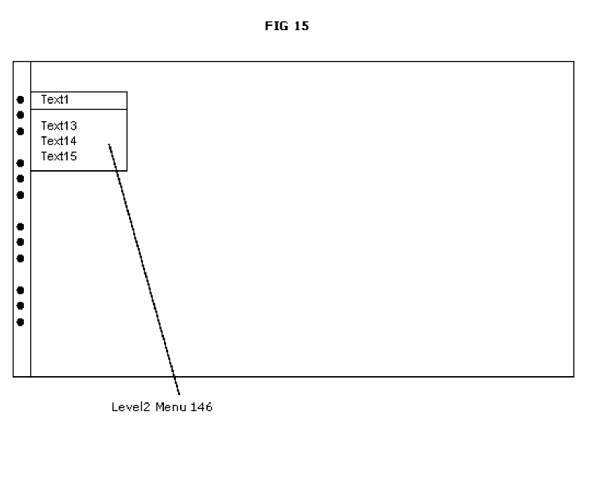

FIG. 15 illustrates an alternate view of the same level of menu navigation, whereby the Main Menu Text 144 (FIG. 13) is eliminated and only the Menu Icons 142 (FIG. 12) remains visible. This mode encroaches less on the Display Space 143 (FIG. 12) area of the UI, but is less intuitive in that the text descriptions of the Menu Icons 142 (FIG. 12) are not visible. One strategy for implementation would be to visually “slide” the Main Menu Text 144 (FIG. 13) and Level2 Menu 145 (FIG. 14) visual elements to the left until the visual structure of the Level2 Menu 146 of FIG. 15 is achieved. This action would be initiated after a predetermined period of time after the initial selection. In a preferred embodiment of the present invention, initiation of this action would also be determined by usage factors designed to predict the familiarity of the user with the interface navigation process.

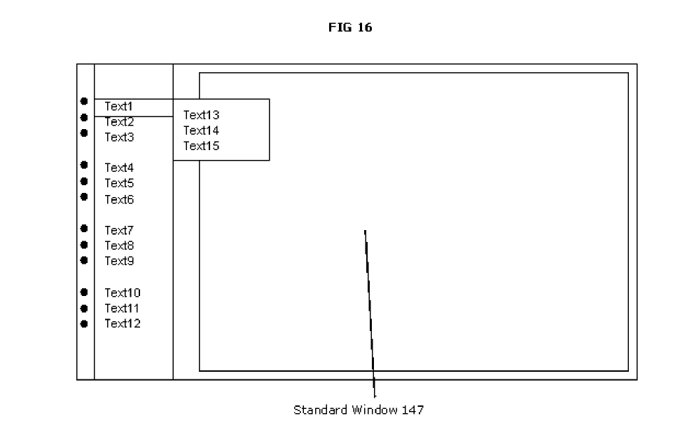

FIG. 16 illustrates how the menu selection shown in FIG. 14 relates to a display window embedded in the UI which runs in standard 4:3 aspect ratio (Standard Window 147). This is relevant in that typical menu text items for the target application, displayed at font sizes necessary for readability at the appropriate distance from the display, results in some overlap with the Standard Window 147 which would typically be displaying TV or movie content during the navigation process.

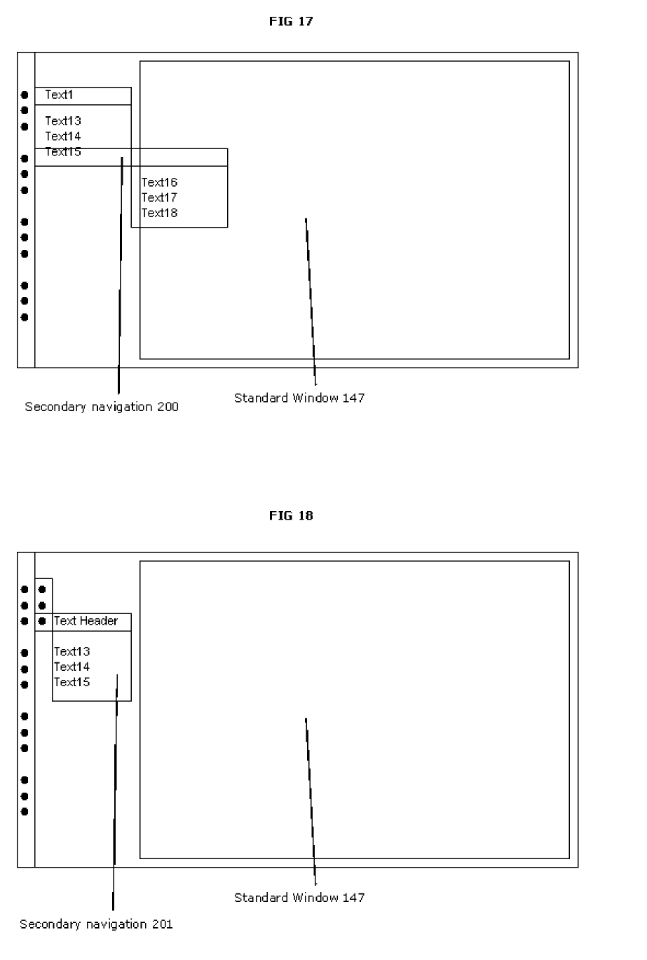

FIG. 17 shows an additional menu navigation level 200 with the Standard Window 147 and further illustrates the necessity for active text elimination strategies to be used while navigating deeper into the sub-menus, so as to minimize interference with normal TV and movie viewing during the process.

FIG. 18 illustrates how a four-level menu tree could be displayed without covering the Standard Window 147 screen area, see menu navigation structure 201.

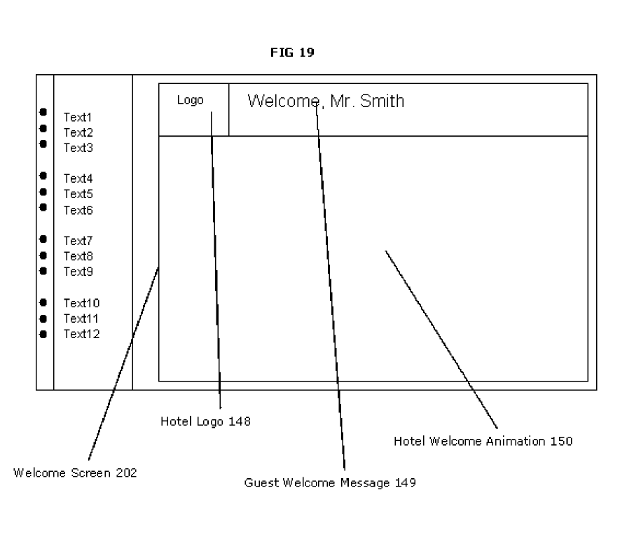

FIG. 19 illustrates a Welcome Screen layout for the Entertainment UI running in a hotel environment. In a preferred embodiment of the present invention, the Welcome Screen 202 would be triggered by the hotel guest inserting the electronic key used to open their hotel door. If this was the first key lock activation since check-in, the Entertainment UI would wake-up the UI from any hibernation mode and present the guest with the content and layout as shown in the figure, including customized Guest Welcome Message 149, Hotel Logo 148 (or other branding images for the hotel), and Hotel Welcome Animation 150. The Hotel Welcome Animation 150 would preferably by motion video or animation, and would preferably include content targeted at the guest based on information the hotel had on previous visits, identified preferences, or demographics data which could be established based on the guest's information delivered on check-in.

Referring again to FIG. 19, The Main Menu View 151 would include the icons and associated text descriptions for each of the level-one menu items, and there would be a strong visual separation between the menu and the remaining screen elements. The rest of the active visual space would include Hotel Welcome Animation 150 and Guest Welcome Message 149 visual elements as shown. The Hotel Welcome Animation 150 is a standard video, animated graphics, or still graphic image file which advises the guest on what information is available on the system, how to navigate the Entertainment UI, and presents any promotional content that the hotel desires to communicate with their guests. The Guest Welcome Message 149 displays guest-specific content which could be as simple as the text message shown (“Welcome, Mr. Smith”) to guest-specific information such as “Your dinner reservations at Restaurant X are confirmed for 8:00 pm tonight.”

Referring again to FIG. 19, the Hotel Welcome Animation 150 and Guest Welcome Message 149 messages display general content for all guests and specific content for a particular guest, respectively. In general, techniques which can meld these two such that general hotel messages appear to be guest-specific messages are preferred.

In addition, most hotels maintain databases of guests who have stayed with one of the parent company's hotels previously. These databases include information about guest demographics and preferences, and are updated as new relevant data is gathered. In a preferred embodiment of the present invention, this database is used to generate a guest-specific Hotel Welcome Animation 150 from “generic” content segments. For example, a large hotel chain could develop a library of short video segments describing various aspects of the hotel services which they wanted to promote. Each individual hotel could develop additional promotional segments which pertained to their specific hotel. Other paid-sponsor or community service organizations could also contribute promotional segments. Each segment has associated with it a target demographics/psychographics profile; the closer the match with the guest, the higher the score and the more likely that segment will be used for a particular guest. Additional business rules can be incorporated into the algorithm to modify the selection based on other factors, such as revenue generated from third-party sponsors.

As a result, the Hotel Welcome Animation 150 and Guest Welcome Message 149 content can be “targeted” to the specific interests and demographics of the hotel guest, making the information more relevant and generally more interesting to the guest. At the same time, paid sponsor content can be targeted in such a way as to improve the media value of the message.

In addition to using this strategy for the initial room entrance after check-in, appropriately modified messages can be displayed at other times during the guest's stay.

1. A large-format interactive display system, the system comprising:
(a) an electronic display larger than 25 inches measured diagonally;
(b) a touch sensor fitted to the electronic display, said sensor facilitating touch navigation over substantially the entire surface of said display;
(c) a computer system configured to display content onto said display; and
(d) a computer/user visual interface program.

2. The system of claim 1, wherein said visual interface program consists of two operating modes, the operating modes further comprising:
(a) the first mode being a default mode that runs when no user input is received for a specified period on inactivity; and
(b) the second mode being an interactive mode which is triggered by a touch input recognized by said touch sensor.

3. The system of claim 2, wherein said first mode comprises predominantly two visual structures, the structures further comprising:
(a) the first structure being a visual media window, said window covering the majority of the display screen area; and
(b) the second structure being a visual call-to-action which includes messages designed to attract users to touch the display system.

4. The system of claim 3, wherein said call-to-action structure is located across the bottom area of the display.

5. The system of claim 4, wherein said call-to-action includes animated text or images.

6. The system of claim 2, wherein said second mode comprises predominantly three visual structures, the structures further comprising:
(a) a multi-level text list structure;
(b) a visual media content window; and
(c) a navigation bar.

7. The system of claim 6, wherein said navigation bar includes interactivity history for reverse navigation and system control functions.

8. The system of claim 2, wherein said second mode includes visual elements which facilitate initiating a two-way live video communications session.

9. The system of claim 1, wherein said visual interface program includes visual elements which facilitate initiating a two-way live video communications session.

10. The system of claim 1, wherein said visual interface program consists of two operating modes, the operating modes further comprising:
(a) the first mode being a default mode that allows user inputs to occur substantially anywhere on the screen surface; and
(b) the second being a wheelchair-accessible mode which facilitates accessing substantially all functionality from below a predetermined level of the user interface.

11. The system of claim 2, wherein said second mode comprises predominantly four visual structures, the structures further comprising:
(a) a multi-level text list structure;
(b) a visual media content window;
(c) a navigation bar; and
(d) a two-way live video communications window.

12. The system of claim 2, wherein said second operating mode includes two versions, one for landscape orientation of a rectangular display, and one for portrait orientation of a rectangular display, the two versions supporting substantially the same functionality and using the substantially the same content.

13. The system of claim 2, wherein said second operating mode includes two versions, one for landscape orientation of a rectangular display, and one for portrait orientation of a rectangular display, the two versions supporting substantially the same functionality and using the substantially the same content.

14. The system of claim 13, wherein the display systems are 16:9 aspect ratios.

15. The system of claim 1, the system further comprising a remote control device which facilitates touch input navigation without direct touch input on the display surface.

16. The system of claim 2, wherein said first mode comprises predominantly two visual structures, the structures further comprising:
(a) the first structure being a visual media window, said window covering the majority of the display screen area; and
(b) the second structure being a functional menu system, said menu system comprising graphic images representing the functions that are triggered when selected.

17. The system of claim 16, wherein said first mode comprises predominantly two visual structures, the structures further comprising:
(a) the first structure being a visual media window, said window covering the majority of the display screen area; and
(b) the second structure being a functional menu system, said menu system comprising graphic images representing the functions that are triggered when selected.

18. The system of claim 16, wherein said second visual structure displays text descriptions of menu icons when any portion of the display receives a user input.

19. The system of claim 17, wherein said second visual structure displays text descriptions of menu icons when any portion of the display receives a user input.

20. The system of claim 16, wherein said first visual structure includes a welcome message for a hotel guest.
